(19) United States
(12) Patent Application Publication
(10) Pub. No.: US 2009/0301580 A1
(43) Pub. Date: Dec. 10, 2009

(54) CONSTANT FLOW VALVE

(76) Inventor: Donald Hillhouse, Silver Springs, NY (US)

Correspondence Address: Woods Oviatt Gilman LLP, 700 Crossroads Bldg, 2 State St., Rochester, NY, 14614, US

(21) Appl. No.: 12/135,304

(22) Filed: Jun. 9, 2008

(51) Int. Cl. F16K 31/12

(52) U.S. Cl. 137/500

(57) ABSTRACT

A valve for maintaining constant fluid flow under conditions of a specified operating inlet pressure and varying inlet pressures in excess of the specified pressure includes a tubular valve body having a fluid flow channel extending between an inlet and outlet. The fluid flow channel includes a first flow path having a first variable volume and cross-sectional area, and a second flow path having a second variable volume and cross-sectional area. The valve further includes an fluid discharge orifice whose cross-sectional area less than the minimum of the first or second variable cross-sectional areas. If the inlet pressure is above or below the specified operating pressure, the variable volumes are caused to change to maintain a substantially constant fluid flow from the valve.

### FIELD OF THE INVENTION

This invention generally relates to fluid flow regulating valves and, more particularly, to flow valves that provide a constant liquid flow rate under conditions of varying inlet pressures.

### BACKGROUND OF THE INVENTION

Flow valves that provide a constant fluid flow under conditions of varying inlet pressure are useful for a wide variety of applications such as, for example, in water lines for plumbing installations, coolant lines for refrigeration systems and hydraulic fluid lines for brake systems, as well as components of sprayer apparatus.

Dillman, U.S. Pat. No. 3,073,350, the disclosure of which is incorporated herein by reference, describes a constant fluid flow valve that includes an inwardly radiating abutment flange at its downstream end and an outwardly radiating flange at its upstream end that includes a series of openings for permitting a desired fluid flow.

May, US Patent Application No. 2003/0079782, the disclosure of which is incorporated herein by reference, describes a flow control valve that includes an annular throttling orifice defined by the relative positions of a flow port and a tapered probe element.

Newton, US Patent Application No. 2006/0267403, the disclosure of which is incorporated herein by reference, describes a constant flow valve having a base section that is divided into a fluid chamber and a spring chamber by a modulating assembly that is supported by a flexible diaphragm within the valve housing.

McCann et al., U.S. Pat. No. 5,097,863, the disclosure of which is incorporated herein by reference, describes a flow control valve for maintaining a constant flow rate that includes a sleeve and a piston, a membrane positioned between the sleeve and the piston, and a spring adjustment member that includes a set screw.

Oyama, U.S. Pat. No. 5,904,335, the disclosure of which is incorporated herein by reference, describes a flow control valve that includes a first fluid chamber, a piston, and a variable-area orifice within the valve housing, and a second fluid chamber connected to the first fluid chamber by a fixed-area orifice.

Okuda et al., U.S. Pat. No. 4,437,493, the disclosure of which is incorporated herein by reference, describes a constant flow control valve that contains a main flow passage whose area is variable with pressure fluctuation, and a by-pass passage mounted along an external periphery of the main flow passage.

### SUMMARY OF THE INVENTION

The present invention is directed to a valve for maintaining constant fluid flow under conditions of a specified operating inlet pressure and varying inlet pressures in excess of the specified pressure. The valve comprises: a tubular valve body comprising an inlet end, an outlet end, and a fluid flow channel extending between the inlet and outlet ends; a cylindrical flow control member axially aligned within the valve body and slidably engageable with an annular flange extending inwardly within the valve body proximate the inlet end; and a compression spring axially aligned within the valve body and acting to cause the flow control member to move within the valve body in response to variations in the inlet pressure.

The flow control member comprises an annular band having a first surface congruent with a surface of the annular flange and a second surface congruent with an interior surface of the valve body; wherein the first band surface and flange surface define a first flow path having a first variable volume and a first variable cross-sectional area. The second band surface and valve body interior surface define a second flow path having a second variable volume and a second variable cross-sectional area.

The valve further comprises an outlet orifice for discharge of fluid from the valve, the outlet orifice having a cross-sectional area less than the minimum of the first or second variable cross-sectional areas.

The first and second variable volumes are substantially equal at the specified operating inlet pressure. If the inlet pressure exceeds the specified pressure, action of the compression spring on the flow control member causes the first variable volume to increase and the second variable volume to decrease, thereby maintaining a substantially constant fluid flow from the valve. A decrease in the inlet pressure below the specified pressure causes the first variable volume to decrease and the second variable volume to increase, thereby maintaining a substantially constant fluid flow from the valve.

### BRIEF DESCRIPTION OF THE FIGURES

FIG. 1 depicts a flow valve of the present invention, to which a nozzle is affixed

FIGS. 2, 3, and 4 are detailed views of the operation of the flow control ember of the valve under conditions of, respectively, specified operating inlet pressure, pressure in excess of the specified operating pressure, and pressure below the specified operating pressure.

### DETAILED DESCRIPTION OF THE INVENTION

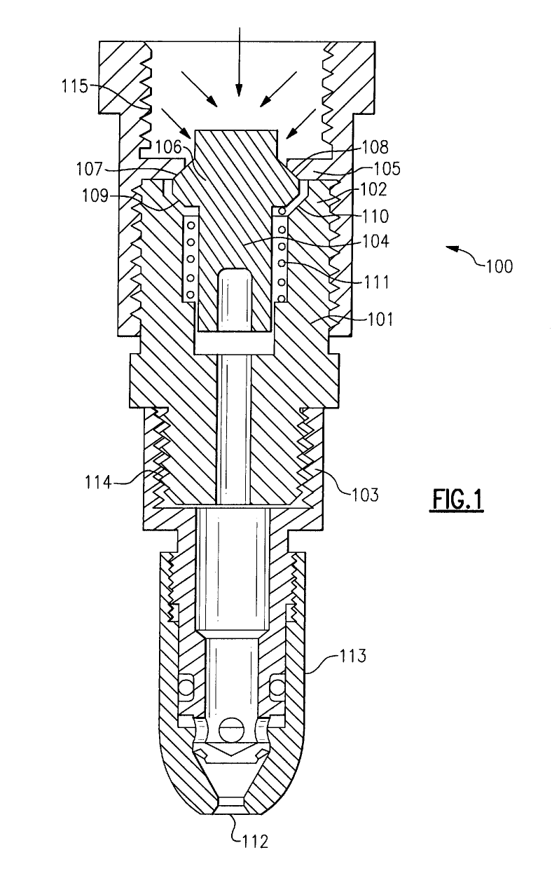

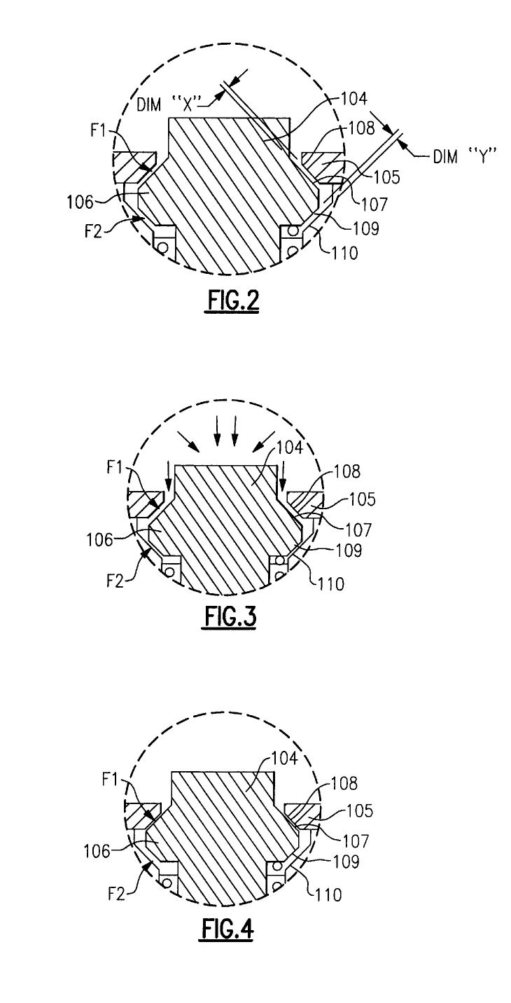

As shown in FIG. 1, a valve 100 comprises a tubular valve body 101 having an inlet end 102, an outlet end 103, and a fluid flow channel extending between inlet end 102 and outlet end 103. A cylindrical flow control member 104 is axially aligned within valve body 101 and is slidably engageable with an annular flange 105 extending inwardly within valve body 101 near inlet end 102. Flow control member 104 comprises an annular band 106 having a first surface 107 congruent with a surface 108 of annular flange 105 and a second surface 109 congruent with an interior surface 110 of valve body 101. First band surface 107 and flange surface 108 define a first flow path F1 (shown in FIGS. 2-4) having a first variable volume and a first variable cross-sectional area, and second band surface 109 and valve body interior surface 110 define a second flow path F2 (shown in FIGS. 2-4) having a second variable volume and a second variable cross-sectional area, wherein the first and second variable volumes are substantially equal at the specified inlet pressure.

Valve 100 further comprises a compression spring 111 axially aligned within valve body 101 and acting to cause flow control member 104 to move within valve body 101 in response to variations in inlet pressure.

Valve 100 also includes an outlet orifice 112 that has a cross-sectional area less than the minimum of the first or second variable cross-sectional area. Outlet orifice 112 may be included in a nozzle 113, which may be connected to valve body 101 by first threading 114. Valve body 101 may further include second threading 115 at inlet end 102 to facilitate attachment of valve 100 to a fluid source (not shown).

When the inlet pressure exceeds the specified operating pressure, the first variable volume is caused to increase and the second variable volume to decrease, thereby maintaining a substantially constant fluid flow from valve 100. Conversely, when the inlet pressure falls below the specified operating pressure, the first variable volume is caused to decrease and the second variable volume to increase, thereby again maintaining a substantially constant fluid flow from valve 100.

FIG. 2 is a detailed view of the operation of flow control member 104 under a condition of dynamic equilibrium at the specified operating inlet pressure, under which condition “X” and “Y’ dimensions are equal, corresponding to equal first and second variable volumes within flow paths F1 and F2, respectively.

As depicted in FIG. 2, at the specified operating inlet pressure the space between first surface 107 of annular band 106 and congruent surface 108 of annular flange 105 is equal to the space between second surface 109 of annular band 106 and congruent interior surface 110 of valve body 101.

FIG. 3 depicts the situation when the inlet pressure exceeds the specified operating pressure. The space between surfaces 107 and 108 defining flow path F1 increases, and the space between surfaces 109 and 110 defining flow path F2 decreases, but the fluid flow rate through valve 100 remains substantially constant.

FIG. 4 depicts a situation that is the converse of that represented by FIG. 3. When the inlet pressure falls below the specified operating pressure, the space between surfaces 107 and 108 defining flow path F1 decreases, and the space between surfaces 109 and 110 defining flow path F2 increases, but again the fluid flow rate through valve 100 remains substantially constant.

As shown in FIGS. 2, 3, and 4, first surface 107 and second surface 109 of annular band 106 are disposed at an angle relative to one another, and surface 108 of annular flange 105 and interior surface 110 of valve body 101 are disposed at the same angle relative to one another as surfaces 107 and 109. Preferably, that angle is about 90 degrees.

The valve of the present invention is particularly suitable for applications requiring the precise spraying of liquid chemical formulations, including those produced by mixing two or more liquids, overcoming a wide range of inlet pressures to maintain a constant outlet pressure determined by a selected spring rate.

While the invention has been described by reference to various specific embodiments, it should be understood that numerous changes may be made within the spirit and scope of the inventive concepts described. Accordingly, it should be recognized that the invention is not limited to the described embodiments but has full scope defined by the language of the following claims.

What is claimed is:

1. A valve for maintaining constant fluid flow under conditions of a specified operating inlet pressure and varying inlet pressures in excess of said specified pressure, said valve comprising:
a tubular valve body comprising an inlet end, an outlet end, and a fluid flow channel extending between said inlet end and said outlet end;
a cylindrical flow control member axially aligned within said valve body and slidably engageable with an annular flange extending inwardly within said valve body proximate said inlet end, said flow control member comprising an annular band having a first surface congruent with a surface of said annular flange and a second surface congruent with an interior surface of said valve body; wherein said first band surface and said flange surface define a first flow path having a first variable volume and a first variable cross-sectional area, and said second band surface and said valve body interior surface define a second flow path having a second variable volume and a second variable cross-sectional area, said first and second variable volumes being substantially equal under the condition of said specified inlet pressure;
a compression spring axially aligned within said valve body and acting to cause said flow control member to move within said valve body in response to variations in said inlet pressure; and
an outlet orifice for discharge of fluid from said valve, said outlet orifice having a cross-sectional area less than the minimum of said first or said second of said variable cross-sectional areas;
wherein an inlet pressure exceeding said specified operating pressure causes said first variable volume to increase and said second variable volume to decrease, thereby maintaining a substantially constant fluid flow from said valve, and further wherein an inlet pressure falling below said specified operating pressure causes said first variable volume to decrease and said second variable volume to increase, thereby maintaining a substantially constant fluid flow from said valve.

2. The valve of claim 1 wherein said first and second surfaces of said annual band are disposed at an angle relative to one another, and said surface of said annular flange and said interior surface of said valve body are disposed at the same angle relative to one another.

3. The valve of claim 2 wherein said angle is about 90 degrees.

4. The valve of claim 1 wherein said outlet orifice is included in a nozzle.

5. The valve of claim 1 further comprising a nozzle adapter.

6. The valve of claim 5 wherein said nozzle adapter comprises threading.

7. The valve of claim 1 wherein said valve body comprises threading at said inlet end to facilitate attachment of said valve to a fluid source.
